(19) United States
(12) Patent Application Publication
(10) Pub. No.: US 2012/0089456 A1
(43) Pub. Date: Apr. 12, 2012

(54) SYSTEM FOR SEARCH BID TERM SELECTION

(75) Inventors: Ankur Gupta, Sunnyvale, CA (US); Arun Kumar Gnanamani, Mountain View, CA (US); Rajesh Koduru, Sunnyvale, CA (US)

(73) Assignee: Yahoo! Inc., Sunnyvale, CA (US)

(21) Appl. No.: 12/899,252

(22) Filed: Oct. 6, 2010

(51) Int. Cl. G06Q 30/00

(52) U.S. Cl. 705/14.45; 705/14.46

(57) ABSTRACT

A system is disclosed for selecting bid terms for search advertising. A bid term selection tool includes a processor to execute an algorithm to provide suggested bid terms. The algorithm includes a cosine similarity function, a modified cosine similarity function, a penalty factor function, and an expected revenue function. The bid term selection tool aggregates the function of the algorithm for potential bid terms and compares the totals for the potential bid terms to select a relevant bid term.

### TECHNICAL FIELD

The present description relates generally to systems and methods for search bid term selection, and more particularly to improving bid term selection in search advertising.

### BACKGROUND

Advertisers create advertisements for the services and products they offer. Pay per click is an example of an advertising model that may be used to charge advertisers for the advertisements they display. In pay per click advertisers pay their host only when their ad is clicked. On the Internet, with search engines, advertisers typically bid on keyword phrases relevant to their target market. Content sites commonly charge a fixed price per click.

Websites that utilize pay per click advertisements display an advertisement when a keyword query matches an advertiser's keyword list, or when a content site displays relevant content. Such advertisements may be referred to as sponsored links or sponsored advertisements, and may appear near results on search engine results pages, or anywhere a web developer chooses on a content site.

### SUMMARY

A system is disclosed for selecting bid terms for search advertising. A bid term selection tool includes a processor to execute an algorithm to provide suggested bid terms. The algorithm includes a cosine similarity function, a modified cosine similarity function, a penalty factor function, and an expected revenue function. The bid term selection tool aggregates the function of the algorithm for potential bid terms and compares the totals for the potential bid terms to select a relevant bid term.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for distributing advertisement impressions.

FIG. 2 is a flow/block diagram illustrating a method and system to select bid terms.

FIG. 3 is a flowchart of an exemplary process for serving advertisements.

FIG. 4 is a flowchart of an exemplary process for bid term selection.

FIG. 5 is an exemplary processing system for executing the advertisement impression forecasting systems and methods.

### DETAILED DESCRIPTION

The systems, methods and techniques generally referred to as systems, described herein relate to improved bid term selection in search advertising. In sponsored search, for example, bid term selection may play an important role in the bid to advertisement selection process. In advanced advertisement selection processes, advertisement selection is not only driven by keyword based matching as in exact match. Ad auction companies may act on the advertisers' behalf to select relevant keywords, e.g., bid terms, which provide a good search user experience as well as improved return on investment for advertisers. Balancing among contextual features match, e.g., relevancy with bid amounts based on a desire or willingness of the advertiser and clickability, e.g., feedback via user perceived relevance, help determine correctly bid terms in the advertisement selection process. Suggested bid terms may be provided to improve relevancy of the search results provided to the search user by using context information from user query, expanding a query context, penalizing for extra and missing features and utilizing prior bid information. As more relevant advertisements are selected, the user experience and clickability of advertisements may be improved, which helps to improve return on investment for an advertiser as well as generate incremental revenue for search providers.

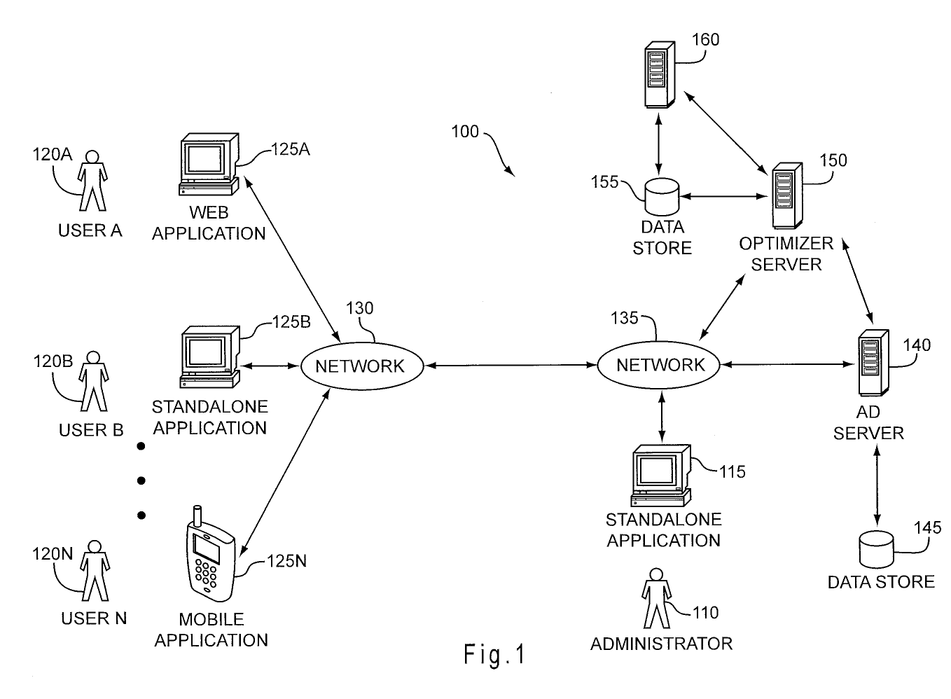

FIG. 1 provides a simplified view of a network environment 100 for serving advertisements, such as on-line advertisement impressions, using the bid term selection system. The bid term selection system may help an advertiser select bid terms that are more likely to match the advertisers' advertisements to users' search queries in a relevant way. Not all of the depicted components may be required, however, and some implementations may include additional components not shown in the figure. Variations in the arrangement and type of the components may be made without departing from the spirit or scope of the claims as set forth herein. Additional, different or fewer components may be provided. The advertisements may be composed of words, sounds, links to web-pages, graphics, etc.

The network environment 100 may include an administrator 110 and one or more users 120A-N with access to one or more networks 130, 135, and one or more web applications, standalone applications, mobile applications 115, 125A-N, which may collectively be referred to as client applications. The network environment 100 may also include one or more advertisement servers 140 and related data stores 145, and one or more optimizer servers 150 and related data stores 155. The users 120 A-N may request pages, such as web pages, via the web application, standalone application, mobile application 125 A-N, such as web browsers. The requested page may request an advertisement impression from the advertisement server 140 to fill a space on the page. The advertiser server 140 may serve one or more advertisement impressions to the pages in accordance with delivery instructions from the optimizer server 150. Alternatively, the advertiser server 140 generates delivery instructions, and an optimizer server 150 is not used. The advertisement impressions may include online graphical advertisements, such as in a unified marketplace for graphical advertisement impressions. Some or all of the advertisement server 140, the optimizer server 150, and the one or more web applications, standalone application, mobile applications 115, 125A-N, may be in communication with each other by way of the networks 130 and 135.

The optimizer server 150 may use a machine learning algorithm. The algorithm may track which advertisements are performing well and in which markets. The optimizer server 150 may also track how advertisements are doing among various races, sexes, age groups, etc. The optimizer server 150 may also ensure that all advertisement get an opportunity for serving. Based on a success among various criteria the advertisement may be classified and grouped. If an advertisement is doing well then the advertisement may be ranked higher and if an advertisement is not doing well then the probability of that advertisement being served may decrease.

A forecasting server 160 may be connected to the data store 155 and other data stores that include advertising related information, including information about users that view the advertisements, types and dates of pages viewed, advertisements viewed, and position of advertisements on pages. The forecasting server 160 may also be connected to the optimizer server 150 and other servers for supplying information, such as information about predicted future advertising inventory. To process large amounts of data used by the forecasting server 160, the forecasting server 160 may employ an array of processors such as through cloud computing 170. More details about an operation of the forecasting server 160 are provided below.

The networks 130, 135 may include wide area networks (WAN), such as the Internet, local area networks (LAN), campus area networks, metropolitan area networks, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-N may be connected to the network 130 in any configuration that supports data transfer. This may include a data connection to the network 130 that may be wired or wireless. Any of the web applications, standalone applications and mobile applications 115, 125A-N may individually be referred to as a client application. The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, tangible memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement server 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE®.

The advertisement server 140 may include one or more of the following: an application server, a mobile application server, a data store, a database server, and a middleware server. The advertisement server 140 may exist on one machine or may be running in a distributed configuration on one or more machines. The advertisement server 140 may be in communication with the client applications 115, 125A-N, such as over the networks 130, 135. For example, the advertisement server 140 may provide a user interface to the users 120A-N through the client applications 125A-N, such as a user interface for inputting search requests and/or viewing web pages. Alternatively or in addition, the advertisement server 140 may provide a user interface to the administrator 110 via the client application 115, such as a user interface for managing the data source 145 and/or configuring advertisements.

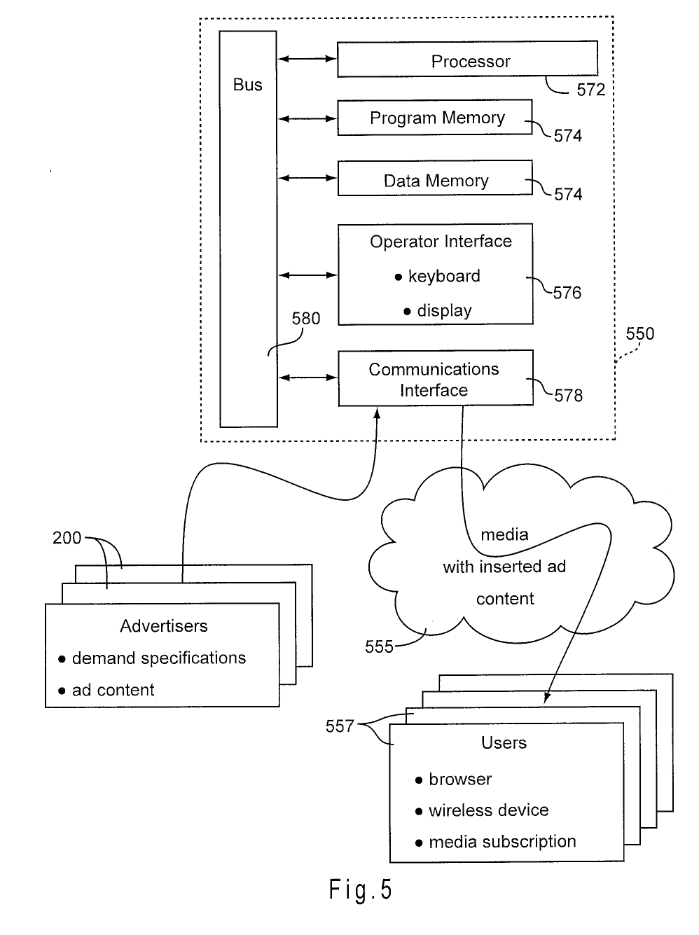

The service provider server 140, optimizer server 160 and forecasting server 160, and client applications 115, 125A-N may be one or more computing devices of various kinds, such as the computing device in FIG. 5. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 125A may employ the Hypertext Transfer Protocol (“HTTP”) to request information, such as a web page, from a web server, which may be a process executing on the advertisement server 140.

There may be several configurations of database servers, application servers, mobile application servers, and middleware applications included in the advertisement server 140. The data store 145 may be part of the advertisement server 140 and may be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols.

The networks 130, 135 may be configured to couple one computing device to another computing device to enable communication of data between the devices. The networks 130, 135 may generally be enabled to employ any form of machine-readable media for communicating information from one device to another. Each of networks 130, 135 may include one or more of a wireless network, a wired network, a local area network (LAN), a wide area network (WAN), a direct connection such as through a Universal Serial Bus (USB) port, and the like, and may include the set of interconnected networks that make up the Internet. The networks 130, 135 may include communication methods by which information may travel between computing devices.

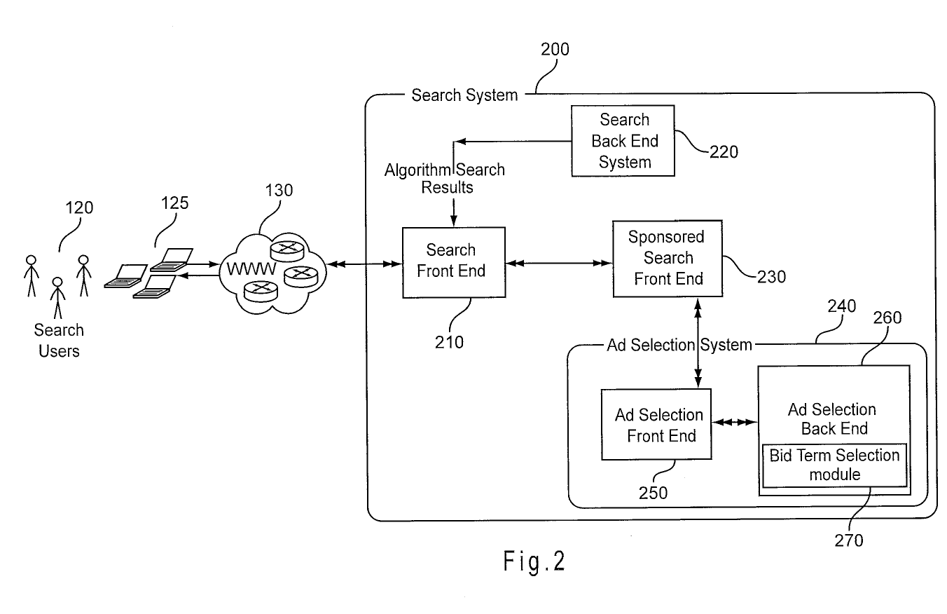

FIG. 2 is a flow/block diagram illustrating of an exemplary search system for bid term selection. The users 120A-N may use a web browser 125A-N to connect to a search system 200 with the network 130. The search system may include a search front end 210 and a search back end 220. The search back end 220 may provide algorithm search results to the search front end 210. The search front end may also connect to receive results from a sponsored search front end 230. The sponsored search front end 230 may connect to access advertisements from an ad selection system 240 that may include an ad selection front end 250 and an ad selection back end 260. The search system 200 may access the ad selection system 240 for selecting advertisements. The ad selection back end 260 may include a bid term selection module 270 for providing bid term selection such as in search advertising over the Internet.

In search advertising, during an advertisement selection process, two major ad matching techniques may be deployed. For exact matches, a normalized form of a user query may be matched with a normalized form of bid keywords. This may also be known as an exact match between a user's intention and services or products that the advertisers are selling. In advanced match, advertisement selection may be based upon a combination of factors in addition to keyword based matching. User queries and advertisements features, that may include the creative, URL and bid keywords, are matched and advertisements may be ranked in order by calculating a quality score of the match based upon mathematical models.

In search advertising, advertisers have flexibility to define multiple keywords or bid terms, and bid differently, related to keywords search frequency and relevancy, under an advertisement unit to target different user queries having similar or extended meaning. During advanced match, after selecting an advertisement, algorithms of the bid term selection module 270 may pick proper bid terms, e.g., relevant keywords. The bid term selection algorithm may generate and utilize keywords similar to those selected by the advertiser, penalize for missing features on both query and bid terms utilizing bid value, e.g., a willingness of an advertiser to attract a click, and account for a probability of a click for a given query, bid term and creative. Results of the bid term selection may be sent to the ad selection front end 250 to be viewed by advertisers for selection.

Advertisers may create and/or select advertisements for the services or products they offer. Several bid keywords representing a particular product or service may be grouped together into an ad-unit. Advertisers have capability to bid on per keyword level. So a single ad-unit may have a set of bid terms with varying bid values. Advertisers may also create a template ad-unit in which the template ad text is replaced with the bid keywords from that ad-unit, sometimes referred to as keyword substitution. The following are some examples of multiple bid keywords under advertisement units.

1) Advertisement Text: 52% Off 3G Bowling Shoes

| Bid Terms | 3g bowling | 3g mens bowling | 3G Mens Sport Deluxe |
|---|---|---|---|
| | shoes | shoes | Black/Blue Right Hand |
| Bid Values | 0.25 | 0.25 | 0.35 |

2) Advertisement Text: Get the Best Value on {KEYWORD:Products}. Find Nextag Sellers' Lowest Price.

| Bid Terms | acer ion | hp modems | hp desks |
|---|---|---|---|
| Bid Values | .10 | .20 | .05 |

3) Advertisement Text: Save at Coastal Contacts TM

| | | | | |
|---|---|---|---|---|
| Bid Terms | get cheap brown | brown color | brown eye | find brown |
| | contacts | contacts | contact | contacts |
| Bid | 11.0 | 1.55 | 0.61 | 4.13 |
| Values | | | | |

4) Advertisement Text: {Keyword:Easy Online Accounting}

| Bid | easy small | simple platinum | fast accounting |
|---|---|---|---|
| Terms | accounting | accounting | degree online |
| Bid Values | 2.69 | 3.80 | 4.55 |

5) Advertisement Text: {KeyWord:Home Movers-Tampa}

| Bid Terms | home moving | home moving | home | home moving |
|---|---|---|---|---|
| | service largo | in tampa | movers | tampa bay |
| | | | valrico | |
| Bid Values | 6.0 | 3.12 | 4.30 | 2.85 |

There could be large variation in bid amounts allocated to different keywords within an ad-unit. The bid term selection module 270 helps to ensure that the advertiser uses relevant bid terms so that a return on investment to the advertiser and search provider may be maximized and relevant advertisements are sent to the users 120A-N for a better user experience.

In the fifth example of an ad-unit, bids vary based upon location name. In the case of second ad-unit, the advertisement text is a template for the type of product. Based on the user query, appropriate bid terms may be selected and the template portion from the advertisement text may be replaced with bid term. For example, if a user is searching for “modems” and a selected bid term is “hp modems”, then the advertisement text may be “Get the Best Value on hp modems. Find Nextag Sellers' Lowest Price”.

For advanced match advertisement selection, bid terms may be selected based upon contextual feature matching, penalties for missing features, and/or a willingness of advertisers to pay a premium for advertisement clicks that are converted to sales. More or less factors may be considered such as incorporating user click feedback into an overall bid term selection process.

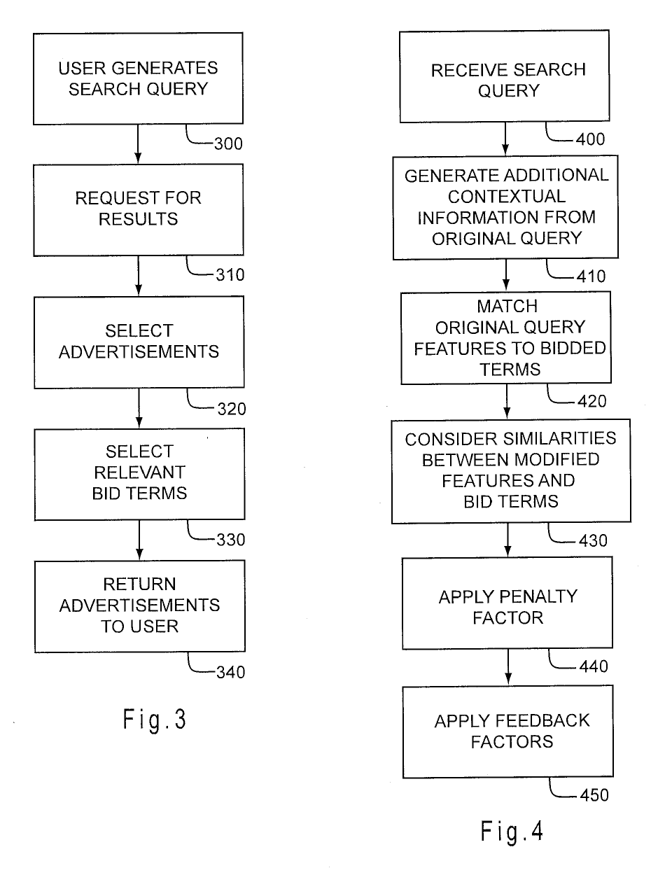

Referring also to FIG. 3, at block 300 one of the users 120A-N generates a search query. The search queries may be sent to the search system 200 via the World Wide Web, Internet, Intranet, Extranet, etc. using web browsers. Results may be returned to the users 120A-N for display by the users 120A-N.

At block 310, the search front end 210 responds to queries of the users 120A-N by requesting algorithmic results from the search back end system 220 and sponsored result listings from sponsored search front end 230. The sponsored search front end 230 sends the user request to ad selection system 240 and receives a list of advertisements relevant for the given query to be displayed to the user. The ad selection system 240 includes the ad selection front end 250 and ad selection back end 260. Once the ad selection system 240 receives a query request from the sponsored search front end 230, the request is forwarded to the ad selection back end 260, where relevant advertisements are selected.

At block 320, the ad selection back end 260 selects advertisements. Advertisements are semantically matched and ranked against user queries and the top ‘N’ candidates are identified to be returned. At block 330, for each advertisement selected, relevant bid terms are selected within bid term selection module 270. At block 340, once the bid term selection has occurred, the top ‘N’ advertisements are returned back to the sponsored search front end 230, which return the advertisements to the search front end 210 to be displayed to the search user 120A-N.

FIG. 4 is a flowchart of an exemplary process for bid term selection. The process may be accomplished with an algorithm using code executed by a processor and tangible memory, hardware, firmware and the like. The following variables may be used:

q: user search query

F(q): set of features for query ‘q’

bt: a given bid term, which can be a candidate for a given query ‘q’

F(bt): set of features for bid term ‘bt’

S(bt): Score for a bided term ‘bt’

Synset(w): Set of synonyms for the word ‘w’ obtained using a lexical database like Wordnet

S(F(q), F(bt)): The cosine similarity between features of query ‘q’ and bid term ‘bt’

At block 400, the advertisement matching system 100 may generate features for a received user search query ‘q’. At block 410, additional contextual information may be generated for the original query using the following technique. For each of the word ‘w’ in the query, a function of synonyms, Synset(w), may be generated. Synonyms may give more context based on the word ‘w’ and are added to the list of existing features of the query ‘q’. A modified query set MOD(q) is created from q with each word ‘w’ in ‘q’ replaced by its synonym. In the example query “tv remote”, the additional features generated may be Synset(“tv”)={television, telecasting}, Synset(“remote”)={remote control}, and MOD(“tv remote”)={“television remote”, “telecasting remote”, tv remote control”, “television remote control”, “telecasting remote control”}. MOD(“tv remote”) may be used to obtain rewrites from the rewrite engine. The re-write engine may be used to generate equivalent forms of the user query based on, for example, users' searching patterns (may be machine learned for the collective), contextual equivalents based on intent, and grammatically related forms of the query, including proper grammar and commonly made mistakes. All the rewrite features along with ones from the original query may provide a broader context for bid term selection.

At block 420, to select relevant bid terms, features from the original query are matched, e.g., using cosine similarity, to the bid terms. For the bid terms that did not match the ones in the query, additional information may be derived from those missing features to aid in term selection process. For example, if the user query was “tv remote” and the bid term candidates are “dvd player remote” and “television accessories”, based on cosine similarity the term “dvd player remote” is selected because of the matching feature “remote.” Missing features like “tv” may be taken from the query and additional contextual information generated, such that the system 100 may match the term “television accessories” to the search query, which is more relevant in this case.

At block 430, in addition to considering the cosine similarity between features from the original query and the bid term, CS(F(q),F(t)), the cosine similarity between features from the modified queries and the bid term may also be considered as follows:

S(bt)=k1*CS(F(q),F(bt))+k2*Sum(CS(F(q′),F(bt))) for each q′ in MOD(q) (1)

where k1 and k2 are configurable parameters such that k1 may be much greater than k2 to give importance to the matching of features from the original query.

Note: In equation (1), if F(q) or F(q′) has only geographical related features, the component CS(F(q),F(t)) becomes 0. Bid terms which match only on geography, e.g., they have no other features like unigrams or phrases matching to the query, do not typically match on the context of the query. A query like “Sunnyvale Pizza” does not match to “Sunnyvale Locksmith” based upon the geographic location information. The second factor in equation (1) may help in selecting bid terms whose missing features were contextually similar to the features from the original query. In this example, bid term “television accessories” is selected because the feature “television” is also present in the modified queries “television remote” and “television remote control”.

After improving the context of the features in the query, some of the features in the bid term may not match those in the query. At block 440, a penalty factor may be applied to the bid term score in equation (1) based on the features in the query not present in the bid term and the features in the bid term not present in the query. The penalty factor PF(q,t) may be as follows:

PF(q,bt)=alphâ(MF(q,bt))*betâ(EF(q,bt)) (2)

where alpha (>1) and beta (>1) are configurable constants based on the length of the query.

MF(q,bt) is the weighted sum (based on the feature type) of weights of features in the query ‘q’ which are missing in the bid term ‘bt’.

EF(q,bt) is the weighted sum (based on the feature type) of weights of features in the bid term ‘bt’ which are missing in the query ‘q’.

S(bt) in equation (1) can then be written by accommodating PF(q,bt) as follows:

S(bt)=k1*CS(F(q),F(bt))+k2*Sum(CS(F(q′),F(bt))) for each q′ in MOD(q)+k3*PF(q,bt) (3)

where k3 (<0) is a configurable constant (e.g. penalty factor) based on experiments.

While selecting the bid term, the bid value, e.g., advertiser willingness to pay for a click to entice a user to buy a product or service, for the bid term and its click history, e.g., perceived user relevance for an ad for a given query and bid term combination, are also indicators. At block 440, when a bid term is selected, feedback related factors may be included in the bid term score as well. The factors may be referred to as the expected revenue represented by ER(bt):

ER(bt)=BID(bt)*PCLICK(q,bt) (4)

where BID(bt) is the bid value provided by the advertiser and PCLICK(q, bt) is the probability of click of an advertisement, given query ‘q’ and bid term ‘bt’. The modified bid term score may be obtained by combining (3) and (4) as:

S(bt)=k1*CS(F(q),F(bt))+k2*Sum(CS(F(q′),F(bt))) for each q′ in MOD(q)+k3*PF(q,bt)+k4*ER(bt) (5)

where k4 is a configurable constant based on experiments. The weights k1, k2, k3 and k4 may be varied depending on implementations and desired outcomes. For example, the weights may vary depending on a particular market and/or advertiser. Exemplary weights include:

0=<k1=<1

0=<k2=<1

−1=<k3=<0(a−ve number)

0=<k4=<1

Values for the weights may be determined experimentally and may be varied based upon business desire. Alternatively or in addition, if an implementation does not use a certain equation, such as the penalty equation, the weight may be set to zero.

To select the bid terms among multiple ones within a given advertisement, S(bt) for each bid term is computed based upon equation (5) and ranked order. The highest score bid term may be considered to be the most relevant or the winner. In such a way, the bid term selection system may help an advertiser select bid terms that are more likely to match the advertisers' advertisements to users' search queries. The bid term selection module 270 may aggregate the functions of the algorithm for potential bid terms and compare the totals for the potential bid terms to select a relevant bid term. Alternatively or additionally, more or less, or other factors may be used, such as conversion of clicks to sales.

FIG. 5 illustrates a practical embodiment as a block level diagram wherein the forecasting system is configured as a computer system 550 that is coupled for data communications, for example to provide media in the form of html web pages and graphics files over a communication path traversing the Internet 555 to various remote users 557, who may be appropriate targets for advertising content provided by advertisers. The computer system 550 can be associated with a service such as a directory service or search engine, or a retail or wholesale outlet or any of various operations whose activities include transmission of media to users 557.

The system 550 as shown can include one or more processors 572, implemented using a general or special purpose processing engine such as a microprocessor, controller or other control logic configuration. In the example shown, processor 572 is coupled via a bus 580 to program and data memory 574, an interface 576 for input/output with a local operator, including, for example, a keyboard, mouse, display, etc., and a communications interface 578. The communications interface is generally shown coupled for communications with advertisers 200 or over the Internet with remote users 557; however it is likewise possible that other specific techniques could be employed to deliver data from the advertiser to system 550, such as hand transferred data carriers, telephone discussions or even paper exchanges. The manner of transmitting media to the users 557 likewise is not limited to web page data transmission and could comprise, for example cable or other video program distribution among other possible embodiments.

The memory 574 of the computing system advantageously includes random access volatile memory and ROM, disc or flash nonvolatile memory for initialization. The program instructions are stored in and executed from the program memory to carry out the functions discussed above. The memory can include persistent data storage for accumulated data respecting advertiser and user information, for example on hard drives. Advantageously, the memory 574 of system 550 can contain locally stored versions of advertising copy that is to be inserted, especially for servicing guaranteed demand. The memory 574 also can receive, preferably store and insert at least some advertising copy from advertisers 22 who undertake to use ad impressions obtained on the ad hoc spot market.

Alternatively or in addition, at least part of the advertising copy to be inserted can be stored remotely and accessed by providing to the browser at the user system the appropriate URLs identifying advertising content to be inserted. For example, system 550 can store and submit to the user browser a network address for graphics or other content to be inserted, which address refers to a system at or associated with the advertiser 22, which system is coupled for web communications and is configured to respond to an IP request for addressed graphic or media content. That content can be obtained by bidirectional IP communications between the browser and the system where the content is stored

The persistent storage devices of memory 574 may include, for example, a media drive and a storage interface for video or other substantial storage capacity needs. The media drive can include a drive or other mechanism to support a storage media. For example, a hard disk drive, a floppy disk drive, a magnetic tape drive, an optical disk drive, a CD or DVD drive (R or RW), or other removable or fixed media drive may be employed. The storage media can include, for example, a hard disk, a floppy disk, magnetic tape, optical disk, a CD or DVD, or other fixed or removable medium that is read by and written to by the media drive.

The terms “computer program medium” and “computer useable medium” and the like are used generally to refer to media such as, for example, memory 574, various storage devices, a hard disk and hard disk drive and the like. These and other various forms of computer useable media may be involved in carrying one or more sequences of one or more instructions to processor 572 for execution. Such instructions, generally referred to as “computer program code” (which may be grouped in the form of computer programs or other groupings), when executed, enable the computing system 550 to perform features or functions of the embodiments discussed herein.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

The network could be the worldwide web and the advertising copy could comprise banner ads, graphics in fields of specific size and placement, overlaid moving pictures or animation, redirection to a different URL, etc. The same targeting abilities are also applicable to networks that are interactive to a lesser degree, such as cable television ad insertion, which might be done at a head end or at a hub, or even from a subscriber-specific set top box.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A system for selecting bid terms for search advertising in response to a query, comprising:
a bid term selection module including a processor to execute an algorithm to provide suggested bid terms, where the algorithm includes,
a cosine similarity function;
a modified cosine similarity function;
a penalty factor function; and
an expected revenue function;
where the bid term selection tool aggregates the functions of the algorithm for potential bid terms and compares totals of the aggregates for the potential bid terms to determine relevant bid terms.

2. The system of claim 1, where the relevant bid terms are the potential bid terms with highest totals for the aggregates.

3. The system of claim 2, further comprising an ad selection system, where the ad selection system selects an advertisement in accordance with the determined relevant bid terms.

4. The system of claim 3, further comprising a search front end to serve the advertisement to the user.

5. The system of claim 1, where the modified cosine similarity function uses keywords that are synonyms to a keyword used in the cosine similarity function.

6. The system of claim 1, where the penalty factor function applies a penalty for features in the query not present in the bid term and the features in the bid term not present in the query.

7. The system of claim 6, where a result of the penalty factor function varies in accordance with a length of the query.

8. The system of claim 1, where the algorithm further includes a function for a conversion of clicks to sales.

9. The system of claim 1, where the expected revenue function uses a bid value and click history.

10. The system of claim 1, where the cosine similarity function and the modified cosine similarity function do not consider features related to geography.

11. A method for selecting bid terms for search advertising in response to a query, comprising:
executing an algorithm to provide suggested bid terms, where the algorithm includes,
a cosine similarity function;
a modified cosine similarity function;
a penalty factor function; and
an expected revenue function;
aggregating the functions of the algorithm for potential bid terms and comparing totals of the aggregates for the potential bid terms to determine relevant bid terms.

12. The method of claim 11, where the relevant bid terms are the potential bid terms with highest totals for the aggregates.

13. The method of claim 12, further comprising selecting an advertisement in accordance with the determined relevant bid terms.

14. The method of claim 13, further comprising serving the advertisement to the user.

15. The method of claim 11, where the modified cosine similarity function uses keywords that are synonyms to a keyword used in the cosine similarity function.

16. The method of claim 11, where the penalty factor function applies a penalty for features in the query not present in the bid term and the features in the bid term not present in the query.

17. The method of claim 16, where a result of the penalty factor function varies in accordance with a length of the query.

18. The method of claim 11, where the algorithm further includes a function for a conversion of clicks to sales.

19. The method of claim 11, where the expected revenue function uses a bid value and click history.

20. The method of claim 11, where the cosine similarity function and the modified cosine similarity function do not consider features related to geography.
